(19) United States
(12) Patent Application Publication
(10) Pub. No.: US 2015/0071298 A1
(43) Pub. Date: Mar. 12, 2015

(54) Hybrid Forwarding in a Virtual Switch

(71) Applicant: Microsoft Corporation, Redmond, WA (US)

(72) Inventors: Robert C. Combs, Redmond, WA (US); Pankaj Garg, Bellevue, WA (US); Luis M. Hernandez, Seattle, WA (US); Claire Elizabeth Mitchell, Redmond, WA (US); Praveen Balasubramanian, Redmond, WA (US)

(73) Assignee: Microsoft Corporation, Redmond, WA (US)

(21) Appl. No.: 14/021,188

(22) Filed: Sep. 9, 2013

(51) Int. Cl. H04L 12/931; H04L 12/721

(52) U.S. Cl. CPC H04L 49/70; H04L 45/44
USPC 370/409

(57) ABSTRACT

Forwarding techniques for a virtual switch are described. A type is identified of data packet received by an extensible virtual switch of a computing device, the extensible virtual switch configured to support communication between a first virtual machine and a second virtual machine or external device. Responsive to the identification, an identifier of the type is associated with the data packet. The data packet is passed through a plurality of extension modules of the extensible virtual switch. Forwarding for the data packet is calculated by at least one of the plurality of extension modules that correspond to the associated identifier.

### BACKGROUND

Virtual machines are software implementations of a physical device that can run programs analogous to a physical device. Virtual machines can oftentimes communicate with one another, as well as other physical devices, using a switch to route the communications between each other.

Virtual machines provide various benefits, but are not without their challenges. One such problem is that situations may arise in which developers desire to implement switches having different functionality. However, conventional techniques that involved designing new switches for each different desired functionality or combination of functionalities can be time consuming and burdensome for a developer.

### SUMMARY

Forwarding techniques for a virtual switch are described. A type is identified of a data packet that is received by an extensible virtual switch of a computing device, the extensible virtual switch configured to support communication between first and second virtual machines Responsive to the identification, an identifier of the type is associated with the data packet. The data packet is passed through a plurality of extension modules of the extensible virtual switch. Forwarding for the data packet is calculated by at least one of the plurality of extension modules that correspond to the associated identifier.

In one or more implementations, a system includes one or more modules implemented at least partially in hardware, the one or more modules configured to implement an extensible virtual switch configured to support communication between virtual machines. The extensible virtual switch includes a packet identification module that is configured to associate an identifier of a type of data packet received by the extensible virtual switch. The extensible virtual switch also includes a plurality of extension modules that are configured to calculate forwarding for the data packet, the calculation performed by at least one of the plurality of extension modules that correspond to the identified type of the data packet.

In one or more implementations, one or more computer-readable storage media comprise instructions stored thereon that, responsive to execution by a computing device, causes the computing device to perform operations. The operations include identifying a type of data packet received by an extensible virtual switch of a computing device, the extensible virtual switch configured to support communication between virtual machines and associating a flag (e.g., an identifier) corresponding to the identified type with the data packet. The operations also include passing the data packet through a plurality of extension modules of the extensible virtual switch and calculating forwarding for the data packet by at least one of the plurality of extension modules that correspond to the flag.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to perform forwarding in a virtual switch.

FIG. 2 illustrates an example implementation of an extensible virtual switch in accordance with one or more implementations.

FIG. 3 depicts a system in an example implementation in which a virtual switch is configured to support hybrid forwarding.

FIG. 4 is a flow diagram depicting a procedure in an example implementation in which a virtual switch includes a plurality of extension modules configured to calculate forwarding for a data packet.

FIG. 5 illustrates an example system including various components of an example device that can be implemented as any type of computing device as described with reference to FIGS. 1-4 to implement implementations of the techniques described herein.

### DETAILED DESCRIPTION

Overview

Virtual switch extensibility is discussed herein. An extensible virtual switch allows virtual machines to communicate with one another and optionally with other physical devices via a network. The extensible virtual switch includes an extensibility protocol binding and miniport driver, allowing different extensions to be added to the extensible virtual switch and thus extending the functionality of the extensible virtual switch. The extensions are loaded on the miniport driver, essentially tying the lifetimes of the extensions to the lifetime of the extensible virtual switch.

Further, this extensible framework may be expanded to support a plurality of different forwarding extension modules. For example, the virtual switch may be configured to identify a type of data packet, which may be generated and injected by an extension module. Forwarding extensions may then be included as part of the virtual switch that calculate forwarding for the data packet based on whether the respective extensions correspond to the identified type. In this way, a single virtual switch may address a variety of different types of data packets.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

Example Environment

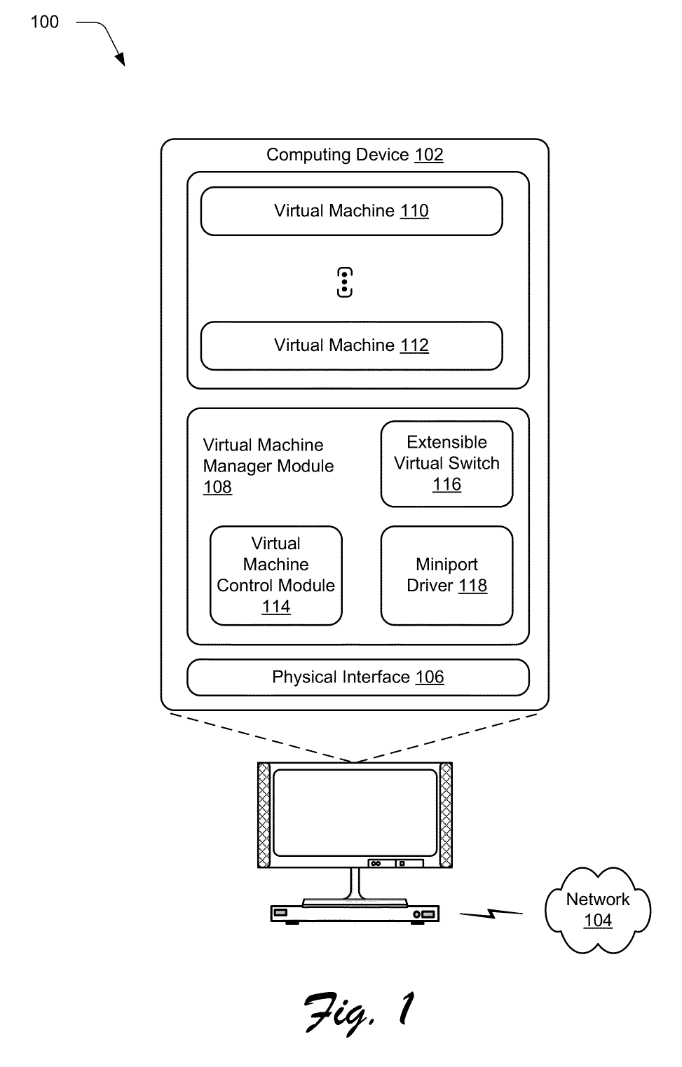

FIG. 1 is an illustration of an environment 100 in an example implementation that is operable to employ techniques described herein. The illustrated environment 100 includes a computing device 102 that is communicatively coupled to a network 104. The computing device 102 may be configured in a variety of ways.

A computing device 102, for instance, may be configured as a computer that is capable of communicating over the network 104, such as a desktop computer as illustrated, a mobile station, an entertainment appliance, a set-top box communicatively coupled to a display device, a wireless phone, a game console, and so forth. Thus, the computing device 102 may range from full resource devices with substantial memory and processor resources (e.g., personal computers, game consoles) to a low-resource device with limited memory and/or processing resources (e.g., traditional set-top boxes, hand-held game consoles). Additionally, although a single computing device 102 is shown, the computing device 102 may be representative of a plurality of different devices, such as multiple servers utilized by a business to perform operations (e.g., a server farm), a remote control and set-top box combination, an image capture device and a game console configured to capture gestures, and so on.

Although the network 104 is illustrated as the Internet, the network may assume a wide variety of configurations. For example, the network 104 may include a wide area network (WAN), a local area network (LAN), a wireless network, a public telephone network, an intranet, and so on. Further, although a single network 104 is shown, the network 104 may be configured to include multiple networks.

The computing device 102 is further illustrated as including a physical interface 106, a virtual machine manager module 108, and one or more virtual machines 110, . . . , 112. The physical interface 106 is representative of a communication component, such as a wired and/or wireless network adapter (e.g., network interface card (NIC)).

Virtual machine manager module 108 is representative of functionality to manage the creation, operation, and termination of virtual machines 110, 112, including access to the functionality provided by physical interface 106 for virtual machines 110, 112. Although a single physical interface 106 is illustrated in FIG. 1, it should be noted that computing device 102 can include multiple physical interfaces of the same and/or different types, and that virtual machine manager module 108 can manage access to the functionality provided by those multiple physical interfaces.

Virtual machine manager module 108 allows one or more virtual machines 110, 112 to run on computing device 102. Any number of virtual machines can run on computing device 102. A virtual machine refers to a software implementation of a computing device (or other machine or system) that is configured to execution programs analogous to a physical computing device. Each virtual machine 110, 112, for instance, may execute an operating system and other applications, and each such operating system and application may be executed without being aware that this execution occurs using a virtual machine and thus this execution may occur without specialized configuration of the applications and other software.

Virtual machine manager module 108 is illustrated as including a virtual machine (VM) control module 114, an extensible virtual switch 116, and a miniport driver 118. Virtual machine control module 114 is representative of functionality to manage the execution of virtual machines 110, 112. This management may include whether to allow the virtual machines to be run (launched) and terminated, controlling migrating of virtual machines from one computing device to another (e.g., between computing device 102 and another computing device via network 104), and so forth.

Extensible virtual switch 116 is configured to allow the virtual machines 110, 112 to communicate with one another as well as optionally other physical devices via physical interface 106 and network 104. As the name implies, the extensible virtual switch 116 is extensible and therefore may be configured to allow different extensions to be added to extensible virtual switch 116 as discussed in more detail below.

Miniport driver 118 is representative of an interface that is configured to provide operations specific to physical interface 106 and allow extensible virtual switch 116 to communicate with physical interface 106. Although a single miniport driver 118 is illustrated in computing device 102, if computing device 102 includes multiple physical interfaces 110 then computing device 102 also typically includes multiple miniport drivers 118, with one corresponding to each physical interface 106.

Although a single extensible virtual switch 116 is illustrated in computing device 102, it should be noted that computing device 102 can include any number of extensible virtual switches. Each extensible virtual switch can allow virtual machines 110, 112 to communicate with one another and/or with other physical devices via physical interface 106 and/or other physical interfaces. Each extensible virtual switch may also have different extensions loaded and/or have extensions loaded in different orders. The loading and ordering of extensions is discussed in more detail below.

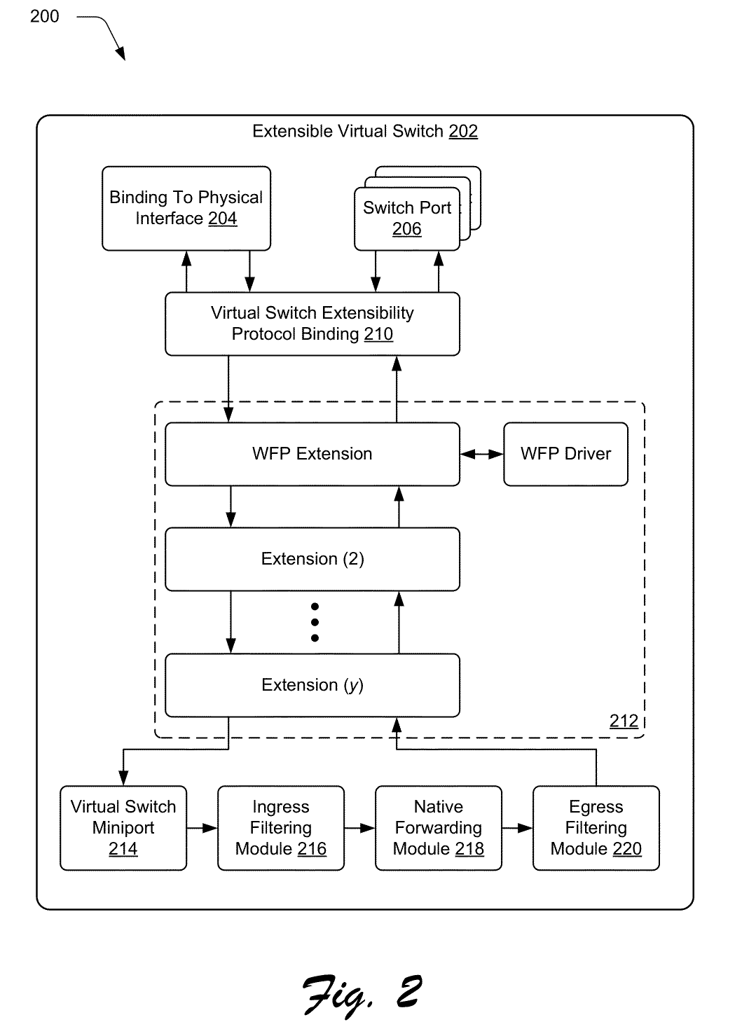

FIG. 2 illustrates an example implementation 200 of an extensible virtual switch 202 in accordance with one or more implementations. Extensible virtual switch 202 can be, for example, an extensible virtual switch 116 of FIG. 1. Extensible virtual switch 202 is illustrated as including a binding to a physical interface 204 and one or more switch ports 206. The binding 204 is configured as a binding to a physical interface and may operate as an interface between extensible virtual switch 202 and a physical interface. The binding 204 may be configured to receive data from and/or send data to a physical interface, typically via a miniport driver, e.g., miniport driver 118 of FIG. 1.

Data is referred to herein as being communicated as data packets. A data packet refers to data plus various metadata associated with the data, such as an indication of the source of the data packet (e.g., a network address or other identifier of a virtual machine, a network address or other identifier of a physical device, etc.), an indication of the target or destination of the data packet (e.g., a network address or other identifier of a virtual machine, a network address or other identifier of a physical device, etc.), and so forth. Thus, a data packet may include a header and a payload, i.e., the information being communicated by the packet. Although discussed herein as being communicated using data packets, it should be noted that data can be communicated using various other data structures.

Each switch port 206 is a communication connection with a virtual machine network adapter, e.g., NIC. A virtual machine (e.g., each virtual machine control module 114 of FIG. 1) may be configured to include a VM network adapter that is similar to (but is a software implementation of) a physical network adapter, such as physical interface 106 of FIG. 1. A VM network adapter can be configured to connect or attach to a switch port 206, and a virtual machine can optionally have multiple VM network adapters each connecting or attaching to a different switch port 206. An operating system as well as other applications can execute on the virtual machine using the VM network adapter as would be performed using a physical network adapter, sending data packets to and receiving data packets from the VM network adapter.

Extensible virtual switch 202 also includes a virtual switch extensibility protocol binding 210. Extensibility protocol binding 210 exposes a set of interfaces that can be used by one or more extensions 212 to extend the functionality provided by extensible virtual switch 202. Extensions 212, for instance, may act as inserted into the data flow path of extensible virtual switch 202, thereby allowing data packets to be modified by extensions 212. Any number (y) of extensions 212 can be inserted into the data flow path of extensible virtual switch 202. Extensions 212 can be configured to support a variety of different functionality, and thus the extensible virtual switch 202 may utilize a variety of different extensions 212 to provide their functionality without modification of the switch. Thus, the extensible virtual switch 202 may be configured to “remain the same” but the functionality provided by switch 202 can be extended using different extensions 212 with different functionality.

Extensible virtual switch 202 is also illustrated as including a virtual switch miniport 214. Virtual switch miniport 214 is representative of an interface that is presented to extensions 212 as if the interface were a conventional miniport drive, e.g., a miniport driver 118 of FIG. 1. However, virtual switch miniport 214 may be configured as an interface that supports the extensibility of extensible virtual switch 202. Data packets received by virtual switch miniport 214 may be passed back through extensions 212 rather than being communicated to a physical interface, as discussed in more detail below. Virtual switch miniport 214 can also be referred to as a hidden miniport or phantom miniport due to miniport 214 being used to support the extensibility of extensible virtual switch 202 rather than communicating data to and/or from a physical interface.

When extensible virtual switch 202 is created (e.g., instantiated) on a computing device, a VM control module (e.g., VM control module 114 of FIG. 1) allows one or more extensions 212 to be loaded on virtual switch miniport 214. Extensions 212 as loaded create an extension stack, analogous to a network stack that may be loaded on a conventional miniport driver (e.g., a miniport driver 118 of FIG. 1), except that the extension stack includes extensions loaded on a hidden miniport or phantom miniport.

The VM control module can determine which extensions are loaded in a variety of different manners. Generally, a request to have an extension loaded is received, such as from the extension itself or another component or module as part of a registration process. The VM control module can approve or disapprove an extension from being loaded, such as based on an identity of a vendor from which the extension is received, based on input from a user or administrator of the computing device running the VM control module, and so forth. Once an extension 212 is approved for loading, the VM control module loads the extension 212 each time the extensible virtual switch 202 is created on the computing device.

The VM control module can also determine the order in which extensions 212 are loaded in a variety of different manners. For example, the order in which extensions are loaded can be received as inputs from a user or administrator of the computing device running the VM control module, can be received from another component or module, and so forth. The VM control module maintains a record of this ordering, and loads extensions 212 in this ordering each time the extensible virtual switch 202 is created on the computing device.

It should be noted that the order in which extensions are loaded can be changed (reordered) at any time, resulting in a different ordering of extensions 212 the next time extensions 212 are loaded. The VM control module can determine the reordered ordering in which extensions are loaded in a variety of different manners. For example, the reordered ordering in which extensions are loaded can be received from a user or administrator of the computing device running the VM control module, can be received from another component or module, and so forth. The VM control module may maintain a record of this reordered ordering, and loads extensions 212 in this reordered ordering each time the extensible virtual switch 202 is created on the computing device (unless the ordering is subsequently changed yet again).

Because extensions 212 are loaded on virtual switch miniport 214, each time the extensible virtual switch 202 is created on the computing device virtual switch miniport 214 is created and the extensions 212 are loaded on the virtual switch miniport 214. Thus, the extensions 212 are automatically loaded each time extensible virtual switch 202 is created. And, the extensions 212 are not loaded if extensible virtual switch 202 is not created. Similarly, if extensible virtual switch 202 is created but then deleted, then in response to deletion of extensible virtual switch 202 both virtual switch miniport 214 and the extensions 212 loaded on virtual switch miniport 214 are also deleted. Thus, the lifetimes of the extensions 212 are tied to the lifetime of extensible virtual switch 202—if extensible virtual switch 202 exists (has been created and is running) then extensions 212 also exist (have been loaded and are running), but if extensible virtual switch 202 does not exist (has not been created or is not running) then extensions 212 do not exist (have not been loaded or have been unloaded).

In one or more implementations, virtual switch extensibility protocol binding 210 conforms to a common protocol, exposing a common application programming interface (API) that can be used by one or more extensions 212. This common API allows communication between extensions 212 and extensibility protocol binding 210. This communication includes communicating data packets, communicating control and/or status information, and so forth. The protocol being a common protocol refers to the protocol being a well-known protocol. In one or more implementations, extensibility protocol binding 210 conforms to the Network Device Interface Specification (NDIS) protocol, including current and/or later versions of the NDIS protocol. However, in other implementations extensibility protocol binding 210 can conform to other versions of the NDIS protocol and/or other protocols (such as the Open Data-Link Interface (ODI) protocol).

It should be noted that, by extensibility protocol binding 210 conforming to the NDIS or other known protocol and by the loading of extensions on virtual switch miniport 214, a break point in extensible virtual switch 202 is exposed as shown by the phantom lines. This break point appears as a conventional network stack to extensions 212, allowing developers of extensions 212 to design extensions 212 to insert into this break point using a known protocol and model that they are accustomed to working with.

Extensions 212 may be configured to work in a virtual machine environment without redesign, as the protocol the extensions 212 would use to communicate with a miniport driver in a non-virtual machine environment is the same protocol that is being supported by extensibility protocol binding 210. Thus, the virtual switch extensibility techniques discussed herein allow developers of extensions 212 to readily use extensions developed for non-virtual machine environments in virtual machine environments, and vice versa.

Virtual switch extensibility protocol binding 210 may be configured to allow one or more extensions to communicate with extensible virtual switch 202, receiving data packets from and/or providing data packets to extensible virtual switch 202. Extensions 212 form an extension stack, each extension receiving a data packet, optionally performing one or more operations based on the data packet, and providing the data packet to the next extension in the stack if appropriate.

Data can be provided bi-directionally in the extension stack, both in an ingress direction and in an egress direction as discussed in more detail below. The ingress direction refers to the direction of data flow from binding 204 or a switch port 206 towards the virtual switch miniport 214, and the egress direction refers to the direction of data flow from the virtual switch miniport 214 towards binding 204 or a switch port 206.

How the extensions 212 provide data packets to one another and/or virtual switch miniport 214 may be determined in a variety of different ways. For example, when an extension 212 is loaded on virtual switch miniport 214, part of the loading process can be establishing (e.g., informing the extensions 212) how to provide data packets to one another and/or virtual switch miniport 214. By way of another example, the manner in which extensions 212 are to provide data packets to one another and/or virtual switch miniport 214 can be inherent in the protocol to which virtual switch extensibility protocol binding 210 conforms.

In one or more implementations, extensions 212 are configured to directly receive data packets from and transfer data packets to other extensions 212. For example, the extension 212 illustrated as “WFP Extension” may receive data packets from extensible virtual switch 202, perform one or more operations based on the data packet, and transfer the data packet to the extension 212 illustrated as “Extension(2)”. Alternatively, extensions 212 can be configured to communicate with other extensions 212 via extensible virtual switch 202. For example, the extension 212 illustrated as “WFP Extension” can receive data packets from extensible virtual switch 202, perform one or more operations based on the data packet, and return the data packet to extensible virtual switch 202, which can then transfer the data packet to the extension 212 illustrated as “Extension(2)”.

Extensions 212 may perform any of a variety of different operations based on the data packet. These operations can include transforming or modifying data packets so that a data packet received by an extension 212 is different than the data packet transferred by that extension 212 to another extension 212. These operations can also include generating or modifying other data based on the data packet so that a data packet received by an extension 212 is the same as the data packet transferred by that extension 212 to another extension 212.

For example, extensions 212 can encrypt and/or decrypt data in a data packet, can perform malware checks on data in a data packet, can monitor where data is being sent to and/or received from, can translate data in a data packet from one format to another, can restrict which other virtual machines another virtual machine can communicate with, can restrict which other physical devices a virtual machine can communicate with, forward a data packet, and so forth. It should also be noted than an extension 212 can simply transfer the data packet to another extension 212 without performing an operation based on the data packet.

In one or more implementations, one or more extensions 212 are protocol conversion extensions, allowing data packets to be converted from one protocol to another. Such a conversion extension may communicate with one or more additional extensions 212 using a different protocol or API, allowing various different extensions 212 to be used even if those extensions do not conform to the same protocol or API as extensibility protocol binding 210. For example, the extension 212 illustrated as “WFP Extension” can receive data packets from extensible virtual switch 202 and convert those data packets from the protocol used by extensibility protocol binding 212 (e.g., the NDIS protocol) to the Windows Filtering Platform (WFP). The extension can communicate with extensibility protocol binding 210 using the NDIS protocol API, can communicate with one or more other extensions using the WFP protocol API, and translates or converts data as appropriate between the NDIS and WFP protocols. Thus, one or more additional extensions 212, such as the extension 212 illustrated as “WFP driver” can be included in extensions 212 even though such additional extensions 212 do not use the same API as extensibility protocol binding 210.

During operation the data flow path for data packets through extensible virtual switch 202 and extensions 212 is as follows. A data packet is received by extensible virtual switch 202 via binding 204 or a switch port 206, and provided to virtual switch extensibility protocol binding 210. Extensibility protocol binding 210 provides the data packet to an extension 212. The extension 212 to which the data packet is provided is the top extension 212 in the extension stack, and the data packet is transferred in the ingress direction through the extension stack.

The order of the extensions may be determined in different manners as discussed above. One extension 212 is determined to be the top of the extension stack, and is the extension 212 illustrated as “WFP Extension” in the example of FIG. 2. Another extension 212 is determined to be the bottom of the extension stack, and is the extension 212 illustrated as “Extension (y)” in the example of FIG. 2. The extension at the top of the extension stack (also referred to as the top extension) is the extension 212 that initially (before any other extension 212) receives data packets from extensible virtual switch 202. The extension at the bottom of the extension stack (also referred to as the bottom extension) is the extension 212 that last (after all other extensions 212) receives data packets prior to transferring the data packets to virtual switch miniport 214. Data packets being transferred from the top of the extension stack to the bottom of the extension stack are also referred to as passing in the ingress direction through the extension stack. Data packets being transferred from the bottom of the extension stack to the top of the extension stack are also referred to as passing in the egress direction through the extension stack.

After passing in the ingress direction through extensions 212, the data packet is received by virtual switch miniport 214. Virtual switch miniport 214 provides the data packet 214 to ingress filtering module 216. Ingress filtering module 216 can perform various filtering of data packets (whether received from binding 204 or a switch port 206), preventing or allowing data packets from being communicated to their requested destination based on various ingress filtering criteria. For example, the ingress filtering criteria can identify (e.g., based on network addresses) one or more data packet sources, and ingress filtering module 216 prevents a data packet from being communicated to its destination if the data packet is received from one of the identified one or more data packet sources.

If ingress filtering module 216 determines the data packet is not allowed to be transferred to its requested destination, then module 216 stops the data packet (e.g., deletes or otherwise ignores the data packet). However, if ingress filtering module 216 determines that the data packet is allowed to be transferred to its requested destination, then ingress filtering module 216 provides the data packet to native forwarding module 218, which performs one or more forwarding operations on the data packet. Generally, such forwarding operations include modifying or generating a network address of the destination of the data packet (as modified, if at all, by extensions 212). For example, the forwarding can include translating the network address of the destination from one format to another, translating the network address of the destination from one network address space to another, and so forth.

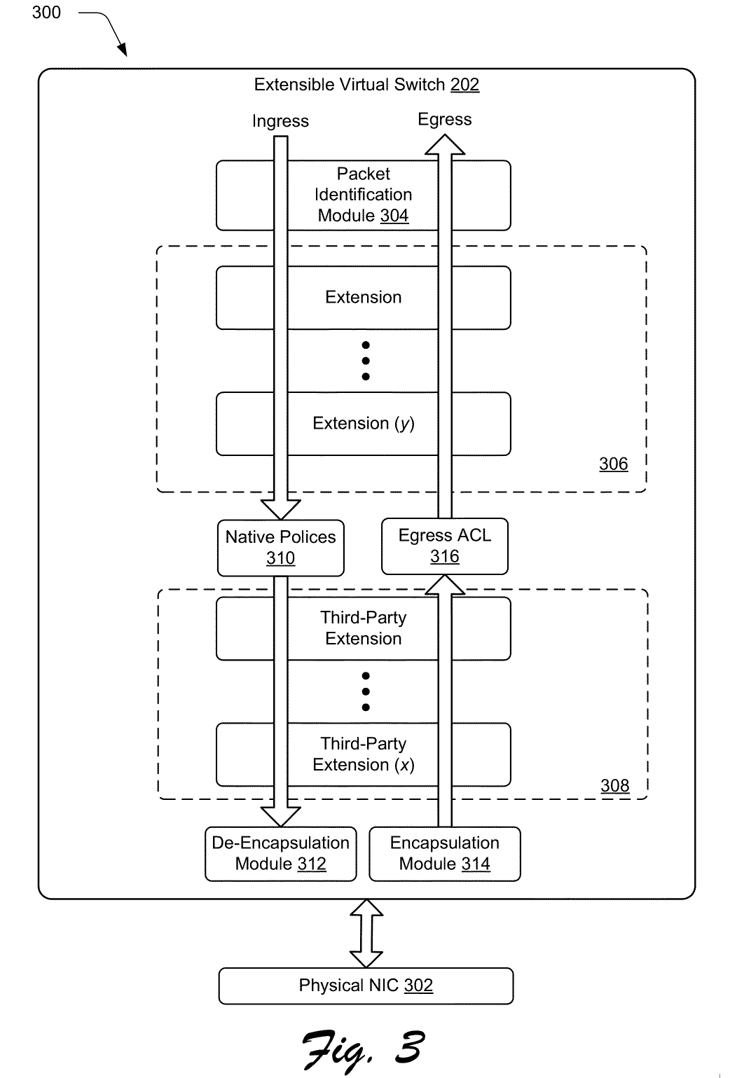

Native forwarding module 218 provides the data packet to egress filtering module 220, which can perform various filtering of data packets, preventing or allowing data packets from being communicated to their requested destination based on various egress filtering criteria. For example, the egress filtering criteria can identify (e.g., based on network addresses) one or more data packet destinations, and egress filtering module 220 prevents a data packet from being communicated to its destination if the destination is one of the identified one or more data packet sources. Forwarding may also be incorporated as part of the extensions as further described in relation to FIG. 3.

If egress filtering module 220 determines the data packet is not allowed to be transferred to its requested destination, then module 220 stops the data packet (e.g., deletes or otherwise ignores the data packet). However, if egress filtering module 220 determines that the data packet is allowed to be transferred to its requested destination, then egress filtering module 220 provides the data packet to an extension 212. The extension 212 to which the data packet is provided is the bottom extension 212 in the extension stack, and the data packet is transferred in the egress direction through the extension stack.

Each extension 212 can perform various operations based on the data packet as the data packet passes in the ingress direction and in the egress direction through the extension stack. It should be noted that an extension 212 need not perform an operation based on each data packet as the data packet passes in the ingress direction and in the egress direction through the extension stack. For example, an extension 212 may perform an operation based on the data packet (e.g., encrypting the data in the data packet) as the data packet passes in the ingress direction through the extension stack, but not perform any operation based on the data packet as the data packet passes in the egress direction through the extension stack. By way of another example, an extension 212 may perform an operation based on the data packet (e.g., encrypting the data in the data packet) as the data packet passes in the ingress direction through the extension stack, and perform another operation based on the data packet (e.g., decrypting the data in the data packet) as the data packet passes in the egress direction through the extension stack.

After passing in the egress direction through extensions 212, the data packet is received by virtual switch extensibility protocol binding 210. Extensibility protocol binding 210 provides the data packet to the appropriate one of binding 204 (which transfers the data packet to its destination via a physical interface) or switch port 206 (which transfers the data packet to its destination virtual machine and/or external machine/device). Extensibility protocol binding 210 can determine whether to provide the data packet to binding 204 or a switch port 206 based on, for example, the network address of the destination of the data packet.

The data flow for each data packet (that is not stopped due to ingress filtering module 216 or egress filtering module 220, or a filter of an extension 212) follows the same paths in the ingress direction and in the egress direction through the extensions 212. Thus, the virtual switch extensibility techniques discussed herein provide a deterministic ordering of the extensions 212 for data packets. Each data packet passes in the ingress direction through the extensions 212 in the extension stack beginning at the same top of the extension stack and finishing at the same bottom of the extension stack, and passes in the egress direction through the extensions 212 in the extension stack beginning at the same bottom of the extension stack and finishing at the same top of the extension stack.

Extensible virtual switch 202 is illustrated as including both binding 204 and one or more switch ports 206. Alternatively, an extensible virtual switch 202 can be implemented that excludes support for communication with other devices via a physical interface. For example, an extensible virtual switch 202 may only support communication among virtual machines, or among virtual machines and a host operating system on the computing device implementing the virtual machines. In such implementations, extensible virtual switch 202 need not include binding 204.

Additionally, in one or more implementations, virtual machine network adapters can have various extension criteria that are to be satisfied by an extensible virtual switch in order for the virtual machine network adapter to connect to an extensible virtual switch. These extension criteria identify various extensions 212 that are to be loaded by an extensible virtual switch and/or are not to be loaded by an extensible virtual switch in order for the virtual machine to use the extensible virtual switch. A virtual machine network adapter has associated extension criteria (e.g., set by a user or administrator), and the virtual machine control module (e.g., module 114 of FIG. 1) verifies that an extensible virtual switch satisfies the associated extension criteria before connecting the virtual machine network adapter to a switch port of the extensible virtual switch.

For example, a particular virtual machine network adapter may be configured to transmit data packets to other physical devices over the Internet, and thus have extension criteria indicating that the extensible virtual switch is to have an extension loaded that performs encryption of data packets. The virtual machine control module verifies that a particular extensible virtual switch has an extension loaded that performs encryption of data packets. If the particular extensible virtual switch has an extension loaded that performs encryption of data packets, then the virtual machine control module allows the particular virtual machine network adapter to connect to that particular extensible virtual switch. However, if the particular extensible virtual switch does not have an extension loaded that performs encryption of data packets, then the virtual machine control module does not allow the particular virtual machine network adapter to connect to that particular extensible virtual switch.

The extension criteria can be used when virtual machines and/or extensible virtual switches are created. For example, the virtual machine control module verifies that a particular extensible virtual switch satisfies the extension criteria when a virtual machine and/or extensible virtual switch is created, and allows or prevents a virtual machine network adapter from connecting to a switch port of the extensible virtual switch based on whether the extensible virtual switch satisfies the extension criteria. The extension criteria can also be used when a virtual machine is migrated from one computing device to another computing device. In one or more implementations, a virtual machine is migrated to another computing device only if an extensible virtual switch on the other computing device satisfies the extension criteria of the virtual machine network adapter. If the extension criteria of the virtual machine network adapter are not satisfied by an extensible virtual switch of another computing device, then the virtual machine having that virtual machine network adapter is not migrated to that other computing device.

Additionally, in one or more implementations, virtual switch extensibility protocol binding 210 receives indications (e.g., via the API exposed by extensibility protocol binding 210) from an extension 212 when that extension 212 desires to perform an operation based on data packets. If one or more extensions 212 desire to perform at least one operation based on data packets, then the data flow path for data packets through extensible virtual switch 202 and extensions 212 is as discussed above. However, if none of extensions 212 desire to perform an operation based on data packets, then the data packets need not be provided to extensions 212. Rather, the data flow path for data packets can be from extensibility protocol binding 210 to virtual switch miniport 214 to ingress filtering module 216 to native forwarding module 218 to egress filtering module 220 to extensibility protocol binding 210, bypassing extensions 212.

FIG. 3 depicts a system 300 in an example implementation in which a virtual switch is configured to support hybrid forwarding. In one or more examples, the extensible virtual switch may be configured to enable a third-party to plug-in a module to add functionality to take over the forwarding capabilities of the switch. This “take over” of the forwarding capabilities may be done as a whole, and therefore the default capabilities may be replaced with the plug-in module. Thus, this is an example of an “either or” approach in which either the default forwarding capabilities were utilized or the capabilities of the replacement module were used. However, this may involve eternal routing for cross format traffic and thus may add a degree of complexity in some instances.

Accordingly, in this example system 300 the extensible hybrid switch 202 may be configured to support forwarding plug-in modules. For example, functionality of the virtual switch 202 may be thought of as involving two parts. The first is the application of policies to the packet, such as policies for filtering (e.g., firewall policies), ACLs, bandwidth limitations, anti-spoofing techniques, transformation policies, and so on. As described above, the virtual switch may be extensible to support third-party polices, which may provide increased richness to the functionality supported by the virtual switch.

The second part may involve computation of the forwarding to determine “where” the packet is to be sent, which may also be configured to support an extensible modules. For example, techniques may be provided to support one or more virtual networks on a single physical network, multiple physical networks, and so on. A multi-tenant encapsulating technology, for instance, may be leveraged to enable multiple virtual networks to be overlaid on a single physical network. This functionality may be incorporated as part of the virtual switch, thereby enabling third-party extensions to coexist with the virtual network functionality.

Accordingly, the virtual switch may be configured to support forwarding computations by a variety of different modules, e.g., default and extensible forwarding modules of the switch, to support these different types of traffic. The virtual switch, for instance, may include an identification module 304 that is configured to identify a type of a packet received by the switch. This identification may then be used to determine which of the modules are to be used to compute the forwarding for a packet. It should be readily apparent that a plurality of different extensible modules (e.g., each of which having a corresponding type of packet traffic) may be added in addition to default forwarding functionality of the virtual switch, the plurality may be used in place of the default functionality, and so on.

The ordering of the extensible forwarding modules may also be configured to support functionality as previously described. For example, each of the extensible modules may include policies that are configured to calculate forwarding of packets due to different factors. Accordingly, an order of the modules may be enforced based on a desired order of the forwarding of these policies, such as to make efficient utilization of computing devices resources. For example, the ordering may be configured such that protective forwarding policies are applied first before other polices (e.g., third-party policies) such that security provided by these policies is not circumvented by the third-party polices. Other examples are also contemplated as previously described in relation to the ordering discussion above.

As shown in the example system 300, the extensible virtual switch 202 is communicatively coupled to a physical NIC 302. The extensible virtual switch 202 in this includes a packet identification module 304, one or more extensions 306 that are native to the extensible virtual switch 202 (e.g., and also extensions that do not provide forward, but instead perform capturing and filtering of traffic) as well as one or more extensions 308 that originated from third-party providers 308. Ingress and egress of packet traffic flow is illustrated through the use of respective arrows.

Thus, packet traffic may first flow into the packet identification module 304 of the extensible virtual switch 202. The packet identification module 304 is representative of functionality to detect a type of packet and from this type determine which of the extensions are to be designated for forwarding of the packet. This identification (e.g., a flag) may be communicated as part of the packet through a stack of extensions.

For example, if the packet is identified for use with one of the third-party extensions 308 the packet may still travel “through” the native extensions for processing, such as for anti-spoofing and other processing as previously described. Native policies 310 may then be applied as appropriate and then the packet may be passed to the third-part extensions 308 for processing (e.g., to calculate forwarding) through use of the identification made by the packet identification module 304.

A de-encapsulation module 312 may then be employed to de-encapsulate the packet, such as to remove external headers and so on to arrive at a payload of the packet. In this way, the packet may be converted into “standard” traffic for communication by the physical NIC 302 as part of ingress processing performed by the extensible virtual switch 202.

Thus, in this example the identification (e.g., the flag) may be used by the modules to determine which module is to calculate the forwarding, e.g., a forwarding table associated with the packet. Further, in this example each of the forwarding extensions may still “see” the packet, as the packet is communicated “through” each of the extensions. Other examples are also contemplated, e.g., where the packet is communicated to one particular extension for computation of the forwarding but not another one of the extensions.

For egress processing, an encapsulation module 314 may be employed to encapsulate the packet for communication. The packet may then be processed by one or more of the third-party extensions 308, an egress ACL 316, and one or more of the native extensions 306 as appropriate. Thus, the traffic going “out into the world” is encapsulated while the internal traffic may be de-encapsulated.

Thus, in this example the extensible virtual switch 202 may address a variety of different formats of tenant isolated traffic that may involve different virtual networks, rather than involve separate switches for each type of traffic. The extensible virtual switch 202, for instance, may build on the plug-in nature of virtual switch extensibility to support multiple forwarding plug-in modules. Traffic may be initially identified for type by the packet identification module 304. This identification of type (e.g., a flag) may then be leveraged by the extension modules 306, 308 to determine which of the modules is to calculate the forwarding for the packet, e.g., a forwarding table. In this way, the extensible modules 306, 308 may be used instead of replacement of the entire extensible virtual switch 202 as in the previous example.

The extensible virtual switch 202 may therefore support a framework that allows multiple forwarding algorithms to exist simultaneously in the virtual switch. This extensibility may be leveraged to allow multiple forwarding extensions to be installed and registered, each per traffic type, and thus may support traffic types that are identified at a later point in time.

Further, each different type of forwarding extension module may be configured to handle one or more types of traffic per registration. The extension modules 306, 308, for instance, may register with the packet identification module 304 to identify the “type” of data that corresponds with the module. In response, the packet identification module 304 may flag those types of data according to the identification. In one or more implementations, data that is not flagged is processed by default forwarding extensions of the virtual switch 202. Further, local virtual machine to virtual machine traffic may be configured to pass through the forwarding modules in the same manner as traffic to/from the external network adapter. A variety of other examples of features are also contemplated without departing from the spirit and scope thereof.

Example Procedures

The following discussion describes virtual switch techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to FIGS. 1-3.

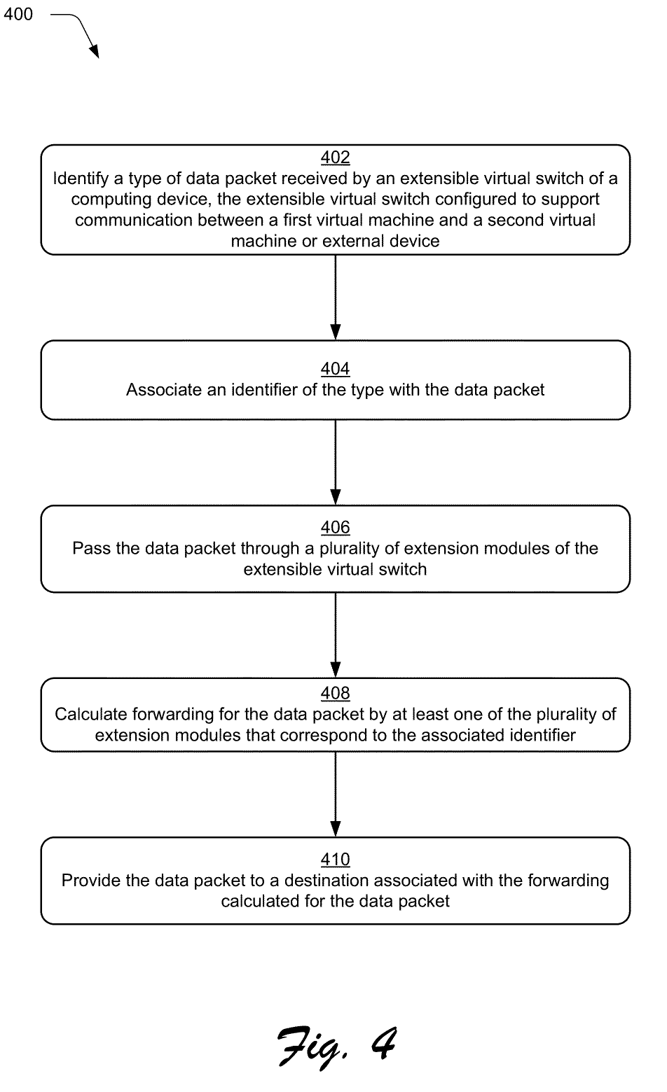

FIG. 4 depicts a procedure 400 in an example implementation in which a virtual switch includes a plurality of extension modules configured to calculate forwarding for a data packet. A type of data packet received by an extensible virtual switch of a computing device is identified, the extensible virtual switch configured to support communication between a first virtual machine and a second virtual machine or external device (block 402). The type, for instance, may identify a native versus third-party type of data packet support by the virtual switch. This type may be registered to the packet identification module 204 as part of installation of one or more third-party extensions 308.

Responsive to the identification, an identifier of the type is associated with the data packet (block 404). This may include “flagging” the packet with the identified type such that the identification is communicated with the data packet through a stack of the forwarding extension modules. A variety of other examples are also contemplated, such as to communication the identification separately.

The data packet is passed through a plurality of extension modules of the extensible virtual switch (block 406). The extension modules, for instance, may be configured as a stack such that the data packet is communicated through each of the extension modules for processing. In this way, security and other processing supported by the extension modules may be maintained without “skipping” relevant processing. Other examples are also contemplated.

Forwarding for the data packet is calculated by at least one of the plurality of extension modules that correspond to the associated identifier (block 408). One or more of the extension modules 306, 308, for instance, may correspond to a flag set for a data packet. Correspondence to this flag may then serve as a basis of whether to perform forwarding calculations for the data packet by the respective forwarding extension modules, such as calculate a destination for the data packet. The data packet may then be provided to the destination associated with the forwarding calculated for the data packet (block 410), such as to a particular one of the virtual machines A variety of other examples are also contemplated.

Example System and Device

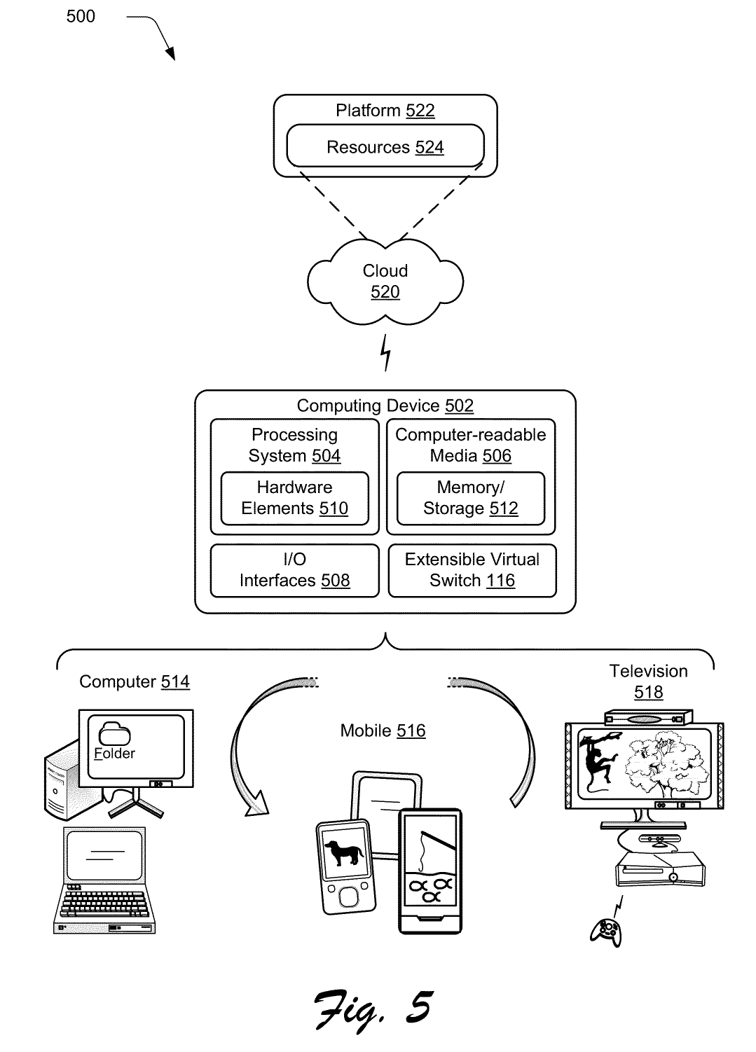

FIG. 5 illustrates an example system generally at 500 that includes an example computing device 502 that is representative of one or more computing systems and/or devices that may implement the various techniques described herein. The computing device 502 may be, for example, a server of a service provider, a device associated with a client (e.g., a client device), an on-chip system, and/or any other suitable computing device or computing system.

The example computing device 502 as illustrated includes a processing system 504, one or more computer-readable media 506, and one or more I/O interface 508 that are communicatively coupled, one to another. Although not shown, the computing device 502 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 504 is representative of functionality to perform one or more operations using hardware. Accordingly, the processing system 504 is illustrated as including hardware element 510 that may be configured as processors, functional blocks, and so forth. This may include implementation in hardware as an application specific integrated circuit or other logic device formed using one or more semiconductors. The hardware elements 510 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 506 is illustrated as including memory/storage 512. The memory/storage 512 represents memory/storage capacity associated with one or more computer-readable media. The memory/storage component 512 may include volatile media (such as random access memory (RAM)) and/or nonvolatile media (such as read only memory (ROM), Flash memory, optical disks, magnetic disks, and so forth). The memory/storage component 512 may include fixed media (e.g., RAM, ROM, a fixed hard drive, and so on) as well as removable media (e.g., Flash memory, a removable hard drive, an optical disc, and so forth). The computer-readable media 506 may be configured in a variety of other ways as further described below.

Input/output interface(s) 508 are representative of functionality to allow a user to enter commands and information to computing device 502, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 502 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 502. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 502, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 510 and computer-readable media 506 are representative of modules, programmable device logic and/or fixed device logic implemented in a hardware form that may be employed in some implementations to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 510. The computing device 502 may be configured to implement particular instructions and/or functions corresponding to the software and/or hardware modules. Accordingly, implementation of a module that is executable by the computing device 502 as software may be achieved at least partially in hardware, e.g., through use of computer-readable storage media and/or hardware elements 510 of the processing system 504. The instructions and/or functions may be executable/operable by one or more articles of manufacture (for example, one or more computing devices 502 and/or processing systems 504) to implement techniques, modules, and examples described herein.

As further illustrated in FIG. 5, the example system 500 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 500, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 502 may assume a variety of different configurations, such as for computer 514, mobile 516, and television 518 uses. Each of these configurations includes devices that may have generally different constructs and capabilities, and thus the computing device 502 may be configured according to one or more of the different device classes. For instance, the computing device 502 may be implemented as the computer 514 class of a device that includes a personal computer, desktop computer, a multi-screen computer, laptop computer, netbook, and so on.

The computing device 502 may also be implemented as the mobile 516 class of device that includes mobile devices, such as a mobile phone, portable music player, portable gaming device, a tablet computer, a multi-screen computer, and so on. The computing device 502 may also be implemented as the television 518 class of device that includes devices having or connected to generally larger screens in casual viewing environments. These devices include televisions, set-top boxes, gaming consoles, and so on.

The techniques described herein may be supported by these various configurations of the computing device 502 and are not limited to the specific examples of the techniques described herein. This functionality may also be implemented all or in part through use of a distributed system, such as over a “cloud” 520 via a platform 522 as described below.

The cloud 520 includes and/or is representative of a platform 522 for resources 524. The platform 522 abstracts underlying functionality of hardware (e.g., servers) and software resources of the cloud 520. The resources 524 may include applications and/or data that can be utilized while computer processing is executed on servers that are remote from the computing device 502. Resources 524 can also include services provided over the Internet and/or through a subscriber network, such as a cellular or Wi-Fi network.

The platform 522 may abstract resources and functions to connect the computing device 502 with other computing devices. The platform 522 may also serve to abstract scaling of resources to provide a corresponding level of scale to encountered demand for the resources 524 that are implemented via the platform 522. Accordingly, in an interconnected device embodiment, implementation of functionality described herein may be distributed throughout the system 500. For example, the functionality may be implemented in part on the computing device 502 as well as via the platform 522 that abstracts the functionality of the cloud 520.

### CONCLUSION

Although the example implementations have been described in language specific to structural features and/or methodological acts, it is to be understood that the implementations defined in the appended claims is not necessarily limited to the specific features or acts described. Rather, the specific features and acts are disclosed as example forms of implementing the claimed features.

What is claimed is:

1. A method comprising:
identifying a type of data packet received by an extensible virtual switch of a computing device, the extensible virtual switch configured to support communication between a first virtual machine and a second virtual machine or external device;
responsive to the identifying, associating an identifier of the type with the data packet;
passing the data packet through a plurality of extension modules of the extensible virtual switch; and
calculating forwarding for the data packet by at least one of the plurality of extension modules that correspond to the associated identifier.

2. A method as described in claim 1, further comprising providing the data packet to a destination associated with the forwarding calculated for the data packet.

3. A method as described in claim 1, wherein the first virtual machine is included on a computing device that is different than the external device.

4. A method as described in claim 1, wherein at least one of the extension modules is configured to calculate forwarding for a native type of data packet and another one of the extension modules is a third-party plug-in module.

5. A method as described in claim 1, wherein the identifier is a flag.

6. A method as described in claim 5, wherein the flag is configured to be communicated with the data packet through the plurality of extension modules.

7. A method as described in claim 1, wherein the plurality of extension modules is arranged in a stack.

8. A method as described in claim 1, wherein the computing device is a single computing device that includes the first and second virtual machines.

9. A method as described in claim 1, wherein the identifying is performed by a packet identification module using a registration of the type that corresponds to the at least one of the plurality of extension modules.

10. A method as described in claim 1, wherein the plurality of extension modules is arranged in an order that is maintained by the extensible virtual switch.

11. A system comprising:
one or more modules implemented at least partially in hardware, the one or more modules configured to implement an extensible virtual switch configured to support communication between virtual machines, the extensible virtual switch comprising:
a packet identification module that is configured to associate an identifier of a type of data packet received by the extensible virtual switch; and
a plurality of extension modules that are configured to calculate forwarding for the data packet, the calculation performed by at least one of the plurality of extension modules that correspond to the identified type of the data packet.

12. A system as described in claim 11, wherein the identifier is a flag that is configured to be communicated with the data packet through the plurality of extension modules.

13. A system as described in claim 11, wherein the plurality of extension modules is arranged as a stack that is configured such that the data packet is communicated through each of the modules in the stack.

14. A system as described in claim 11, wherein the packet identification module is configured to identify the type of the data packet using a registration of the type that corresponds to a respective one of the plurality of extension modules.

15. A system as described in claim 11, wherein the one or more modules are part of a computing device that implements the extensible virtual switch and the virtual machines.

16. A system as described in claim 11, wherein the plurality of extension modules are arranged in an order for processing of the data packet, the order maintained by the extensible virtual switch.

17. One or more computer-readable storage media comprising instructions stored thereon that, responsive to execution by a computing device, causes the computing device to perform operations comprising:
identifying a type of data packet received by an extensible virtual switch of a computing device, the extensible virtual switch configured to support communication between virtual machines;
associating a flag corresponding to the identified type with the data packet;
passing the data packet through a plurality of extension modules of the extensible virtual switch; and
calculating forwarding for the data packet by at least one of the plurality of extension modules that correspond to the flag.

18. One or more computer-readable storage media as described in claim 17, wherein the plurality of extension modules is arranged as a stack that is configured such that the data packet is communicated through each of the modules in the stack.

19. One or more computer-readable storage media as described in claim 17, wherein the packet identification module is configured to identify the type of the data packet using a registration of the type that corresponds to a respective one of the plurality of extension modules.

20. One or more computer-readable storage media as described in claim 17, wherein the plurality of extension modules are arranged in an order for processing of the data packet, the order maintained by the extensible virtual switch.
